(19) United States
(12) Patent Application Publication
(10) Pub. No.: US 2007/0273598 A1
(43) Pub. Date: Nov. 29, 2007

(54) Luneberg Lens Antenna Device

(76) Inventors: Masatoshi Kuroda, Osaka (JP); Masao Yokota, Osaka (JP)

Correspondence Address: MCDERMOTT WILL & EMERY LLP, 600 13TH STREET, N.W., WASHINGTON, DC, 20005-3096, US

(21) Appl. No.: 10/588,276

(22) PCT Filed: Feb. 3, 2005
(86) PCT No.: PCT/JP05/01605

§ 371 Date: Jun. 8, 2007

(30) Foreign Application Priority Data
Feb. 6, 2004 (JP) 2004-030981

(51) Int. Cl. H01Q 19/06

(52) U.S. Cl. 343/753

(57) ABSTRACT

An easy-to-install Luneberg lens antenna device is constituted by combining a hemispherical Luneberg lens and a radio wave reflector. The Luneberg lens antenna device comprises an antenna fixing jig (2), and a fixing means, e.g., a bolt (3), for fixing the radio wave reflector (1b) of the antenna device (1) removably to the antenna fixing jig (2). The reflector (1b) and the antenna fixing jig (2) are previously provided, respectively, with fixing parts for fixing by the fixing means, the antenna fixing jig (2) is fixed to an antenna installing section and the reflector (1b) is fixed to the antenna fixing jig (2) by the fixing means.

### FIELD OF THE INVENTION

The present invention relates to an easy-to-install Luneberg lens antenna device.

### BACKGROUND OF THE INVENTION

Luneberg lens antenna devices are being spotlighted as an antenna device for transmitting and receiving radio waves to and from a plurality of geostationary satellites. One of the Luneberg lens antenna devices attains equivalent functions to a spherical lens by combining a hemispherical Luneberg lens and a radio wave-reflecting plate for the purpose of compactness or miniaturization.

As one method of installing such a Luneberg lens antenna device having a reflective plate, International Application No. PCT/JP2002/09179 (“Reference 1”) filed in the name of the present applicant discloses a method wherein a reflective plate is directly attached to a wall surface or the like by screw-securing or suspending it at an antenna installation area.

In a conventional parabolic antenna for satellite broadcast reception, however, it is necessary to make reception adjustment by preliminarily fixing the antenna and then moving a reflective plate. Although the reflective plate is attached to a pole for the reception adjustment, it is impossible to stably support the reflective plate on a plane extending along a wall surface or a fence because the reflective plate has a concave shape.

In contrast, in the Luneberg lens antenna device with a reflective plate, a primary feed can be positioned at a focus point of radio waves by adjusting the angle of an arm which holds the primary feed or the position of the primary feed on the arm. This eliminates the need for fine adjustment of the orientation of the reflective plate. Furthermore, the reflective plate is of a planar shape, which makes it possible to stably secure the reflective plate along the broad surface of a wall or the like as closely as it gets.

However, the Luneberg lens antenna device has a drawback in that it cannot be easily installed with the installation method disclosed in Reference 1 occasionally.

Specifically, in the event that a screw-holding anchor or a hook receiver is affixed to, e.g., a wall surface, the fixing position thereof has to be set in advance. At this time, there is a need to mark the fixing position while an assistant holds up the antenna device of heavyweight nature. Further, when screws are fitted into the fixed anchor to finally secure the reflective plate, the assistant should continue to hold up the antenna device until several screws are tightened in their entirety. Moreover, the anchor or the like may be affixed to a wrong position in which case it should be relocated to a correct position. Such tasks are difficult to perform and time-consuming.

### SUMMARY OF THE INVENTION

It is, therefore, an object of the present invention to provide an easy-to-install Luneberg lens antenna device having a reflective plate.

In accordance with an aspect of the present invention, there is provided a Luneberg lens antenna device, including: an antenna fixing bracket; an antenna body comprised of a hemispherical Luneberg lens and a reflective plate for reflecting radio waves; and a fixing means for detachably affixing the reflective plate of the antenna body to the antenna fixing bracket, wherein fixing parts for cooperating with the fixing means are provided in advance on the reflective plate and the antenna fixing bracket, the antenna fixing bracket is secured to an antenna installation area, and the reflective plate is affixed to the antenna fixing bracket by using the fixing means.

The fixing means, for detachably affixing the reflective plate of the antenna body to the antenna fixing bracket, may include a combination of a bolt and a threaded hole into which the bolt is fitted, a combination of a bolt-receiving hole, a bolt inserted into the bolt-receiving hole and a fastening nut, a combination of a hook and a hook receiver, a combination of a plug and a socket, a combination of an engaging groove and a member engaged with the engaging groove, a combination of a pin and connector members coupled by the pin, a combination of a band and a band hanger, and a combination of a pole and members for sandwichedly fastening the pole therebetween.

In accordance with the antenna device of the present invention, an antenna fixing bracket which is provided independently of an antenna body is secured to an antenna installation area. After that, the antenna body is affixed to the antenna fixing bracket by means of the fixing means.

The task of securing the antenna fixing bracket to the antenna installation area can be performed in a convenient manner, because the antenna body of heavyweight nature is separated from the antenna fixing bracket. Furthermore, due to the fact that fixing parts for cooperating with the fixing means are provided in advance on the reflective plate and the antenna fixing bracket, the antenna body can be affixed to the antenna fixing bracket without having to correct a fixing position. This makes it possible to install the Luneberg lens antenna device in a simpler manner than the conventional installation method.

### BRIEF DESCRIPTION OF THE DRAWINGS

FIGS. 1A and 1B are a side and a front view of a preferred embodiment of a Luneberg lens antenna device in accordance with the present invention, respectively.

FIGS. 2A and 2B illustrate a side and a front view of another preferred embodiment, respectively.

FIG. 3 depicts a side view of a still another preferred embodiment.

FIG. 4 presents a side view of a still another preferred embodiment.

FIG. 5A shows a side view of a still another preferred embodiment and FIG. 5B is a view illustrating a hook engaged with a hook receiver.

FIG. 6A sets forth a side view of a still another preferred embodiment and FIG. 6B is a perspective view illustrating the details of a hook and a hook receiver.

FIG. 7A is a side view of a still another preferred embodiment and FIG. 7B is a perspective view illustrating the details of a hook and a hook receiver.

FIG. 8 shows a side view of a still another preferred embodiment.

FIG. 9 is a side view of a still another preferred embodiment.

FIG. 10A depicts a side view of a still another preferred embodiment and FIG. 10B is a perspective view illustrating an engaging groove and engaging portions.

FIG. 11 is a front view of a modification of the engaging grooves and the engaging portion in FIGS. 10A and 10B.

FIGS. 12A and 12B are a side and a top view of a still another preferred embodiment, respectively.

FIG. 13 shows a side view of a still another preferred embodiment.

FIG. 14 is a side view of a still another preferred embodiment.

FIGS. 15A and 15B are a side and a bottom view of a still another preferred embodiment, respectively.

FIGS. 16A and 16B demonstrate a side and a top view of a still another preferred embodiment, respectively.

FIG. 17 is a side view of a preferred embodiment of a horizontally oriented antenna device.

FIG. 18 sets forth a side view of another preferred embodiment of the horizontally oriented antenna device.

FIG. 19 depicts a side view of a still another preferred embodiment of the horizontally oriented antenna device.

FIG. 20 depicts a side view of a still another preferred embodiment of a horizontally oriented antenna device.

FIG. 21 illustrates a side view of a still another preferred embodiment of a horizontally oriented antenna device.

FIG. 22 shows a side view of a still another preferred embodiment of a horizontally oriented antenna device.

FIG. 23 is a side view of another example of the antenna fixing bracket.

### DESCRIPTIONS OF REFERENCE NUMERALS

1: antenna body
1a: Luneberg lens
1b: reflective plate
2: antenna fixing bracket
3, 21, 23: bolt
4: attachment
5: fixing member
6, 12, 24: nut
7: hook
8: hook receiver
9: plug
10: socket
11: set screw
13, 25: engaging groove
14, 15: connector member
16: pin
17: band
18: band hanger
19: stopper
20: mast
22: retainer
26: mooring member
27: caster with stopper
28: weight

### BEST MODE FOR CARRYING OUT THE INVENTION

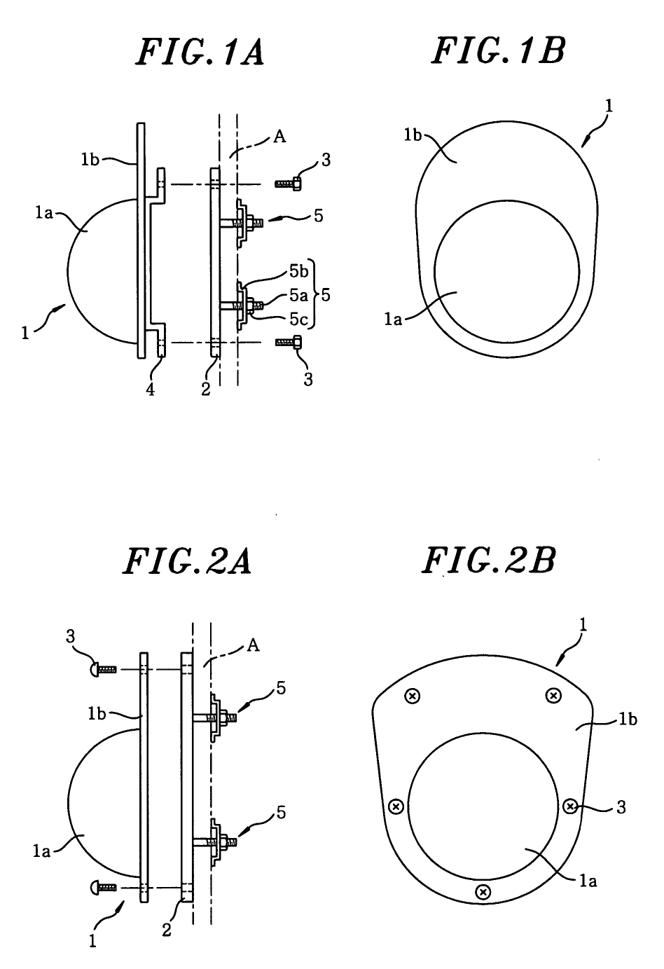

Preferred Embodiments of a Luneberg lens antenna device in accordance with the present invention will now be described with reference to the accompanying drawings. The Luneberg lens antenna device shown in FIG. 1 includes an antenna body 1, an antenna fixing bracket 2 and bolts (fixing unit) 3 for affixing the antenna body 1 to the antenna fixing bracket 2.

The antenna body 1 is constructed by combining a hemispherical Luneberg lens 1a and a reflective plate 1b for reflecting radio waves. In addition to the antenna body 1, the Luneberg lens antenna device further includes a protective cover capped on a surface of the Luneberg lens 1a, a primary feed (LNB: low noise block down converter) for receiving and transmitting the radio waves and an elevation-angle-adjustable arm for holding the primary feed in such a manner that the azimuth angle thereof can be adjusted. These elements are not shown in the drawings. The elements omitted from illustration are affixed to the antenna body 1 or the antenna fixing bracket 2.

An attachment 4 is secured to the rear surface of the reflective plate 1b so as to face the front surface of the antenna fixing bracket 2.

The antenna fixing bracket 2 is provided with a fixing member 5 with respect to an antenna installation area. As shown, the fixing member 5 includes a bolt 5a integrally provided on the rear surface of the antenna fixing bracket 2, a metal retainer 5b fitted onto the bolt 5a and a nut 5c threadedly fastened onto the bolt 5a such that a veranda fence “A” or the like is sandwichedly positioned between the antenna fixing bracket 2 and the metal retainer 5b. With such configurations, the antenna fixing bracket 2 is affixed to the fence “A” or the like in advance, and the bolts 3 are then fitted through bolt-receiving holes (fixing parts) of the antenna fixing bracket 2 into threaded holes (fixing parts) formed in the attachment 4. This enables the antenna body 1 to be affixed to the antenna fixing bracket 2 in a simple manner.

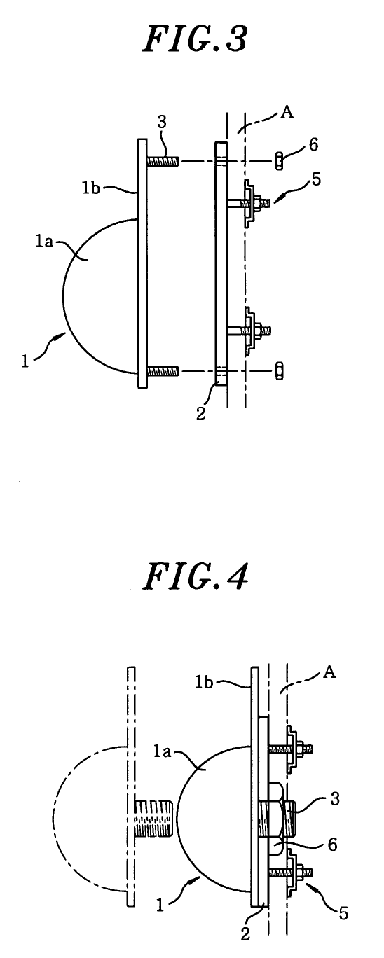

Alternatively, as illustrated in FIG. 2, the bolts 3 may be fitted through bolt-receiving holes formed in the reflective plate 1b into threaded holes of the antenna fixing bracket 2. Further, as depicted in FIG. 3, the bolts 3 are integrally provided on the rear surface of the reflective plate 1b and inserted through the bolt-receiving holes of the antenna fixing bracket 2, after which nuts 6 are fastened onto the bolts 3 so that the antenna body 1 can be affixed to the antenna fixing bracket 2. In the embodiments shown in FIGS. 1 through 3, there are preferably provided three or more fastening portions tightened by the bolts 3.

As shown in FIG. 4, the bolt 3 and the nut 6 may be engaged with each other at the center of the antenna body 1. A rotation-proof portion (not shown) for inhibiting any rotation of the antenna body 1 may be provided between the antenna fixing bracket 2 and the antenna body 1, and use of the single set of bolt and nut in combination with the rotation-proof portion reduces the number of working steps in installing the antenna device.

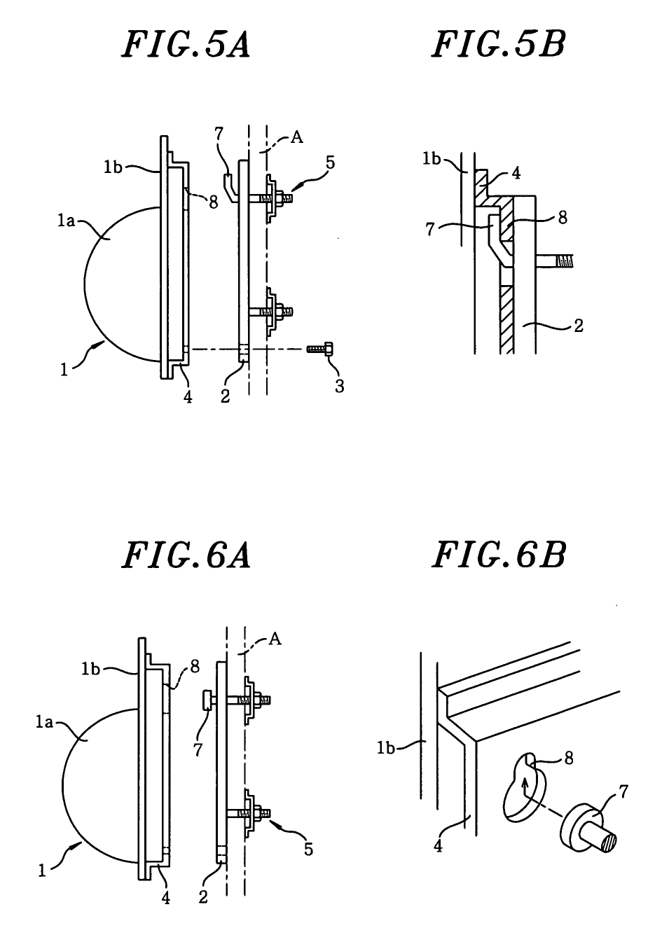

In another preferred embodiment shown in FIG. 5, a hook 7 and a hook receiver 8 are provided in a mutually corresponding relationship on the antenna fixing bracket 2 and the attachment 4 of the same configuration as illustrated in FIG. 1. The antenna body 1 is hung on the antenna fixing bracket 2 by means of the hook 7 and the hook receiver 8. In order to prevent the separation of the hook 7 from the hook receiver 8, the antenna body 1 is preferably secured at its lower side to the antenna fixing bracket 2 by using the bolt 3 and the like.

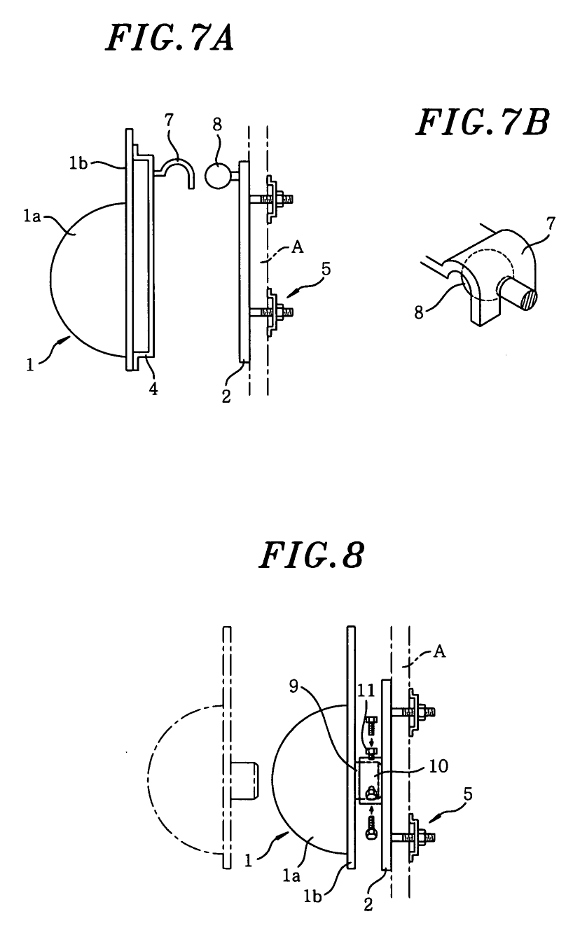

The hook 7 and the hook receiver 8 may be of a shape as illustrated in FIG. 6 or FIG. 7. The hook 7 may be provided on the antenna body 1 and the hook receiver 8 may be formed on the antenna fixing bracket 2. In case the installation of the antenna body is conducted only by using the hook 7 and the hook receiver 8, three or more sets of the hook 7 and the hook receiver 8 are preferably used so as to prevent the antenna body from being displaced.

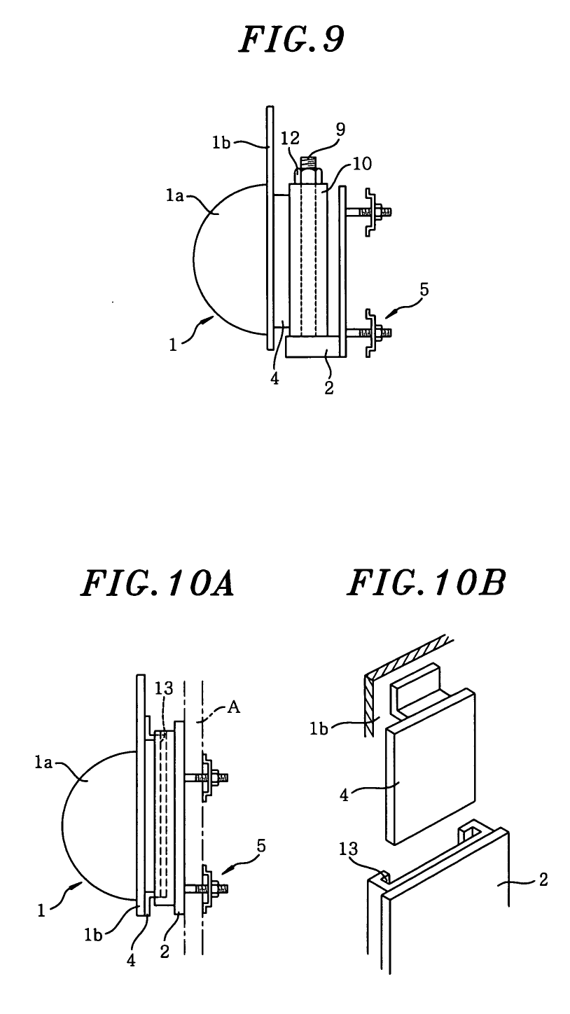

FIGS. 8 and 9 show still other preferred embodiments wherein a plug 9 and a socket 10 are employed as fixing means for affixing the antenna body 1 to the antenna fixing bracket 2. In the embodiment shown in FIG. 8, the plug 9 and the socket 10 are engaged with each other in a transverse direction. A set screw 11 is used to inhibit any removal of the plug 9.

In the embodiment illustrated in FIG. 9, the socket (sleeve in FIG. 9) 10 is externally fitted onto the plug (upright threaded shaft in FIG. 9) 9. A nut 12 is threadedly coupled onto the plug (threaded shaft) 9 from the top thereof to prevent any rotation of the socket 10, thus keeping the antenna body in a selected orientation.

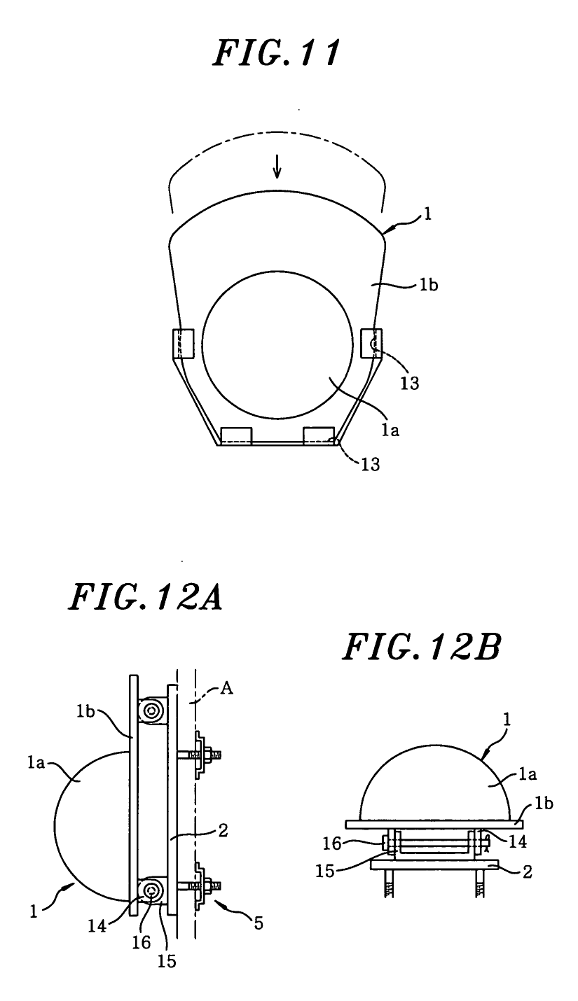

FIGS. 10 and 11 illustrate still other preferred embodiments wherein a slide-fitting manner is used to affix the antenna body 1 to the antenna fixing bracket 2. In the embodiment illustrated in FIG. 10, the antenna fixing bracket 2 is provided with a T-shaped slot serving as an engaging groove 13. Right and left lateral edge portions of the attachment 4 are inserted into the engaging groove 13 from the top thereof, thereby affixing the antenna body 1 to the antenna fixing bracket 2. The engaging groove 13 may be a dovetail groove. Moreover, the engaging groove 13 may be comprised of a plurality of separate groove segments as shown in FIG. 11. As far as there is no interference with the electric performance of the antenna, the peripheral edges of the reflective plate 1b may be used as the engaging portions and may be directly inserted into the engaging groove 13, as illustrated in FIG. 11.

Referring to FIG. 12, connector members 14 and 15 each having a pin-receiving hole may be provided in a mutually corresponding relationship on the antenna body 1 and the antenna fixing bracket 2, respectively. The connector members 14 and 15 may be coupled together by removably inserting a pin 16 into the pin holes of the connector members 14 and 15.

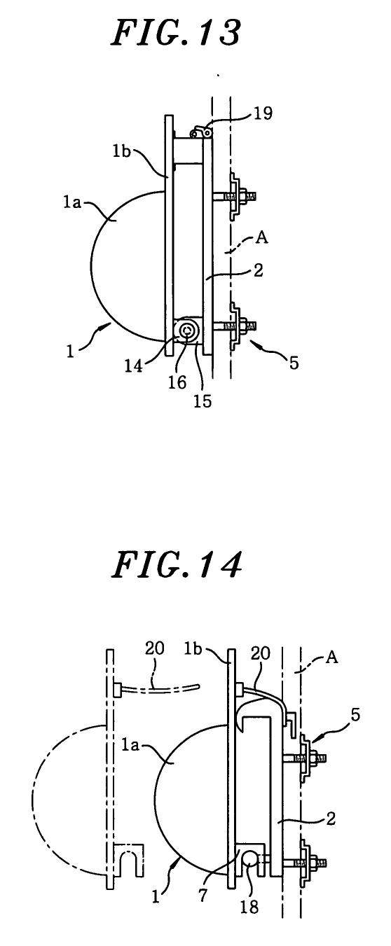

As shown in FIGS. 13 and 14, different kinds of fixing means may be used in combination to detachably affix the antenna body 1 to the antenna fixing bracket 2. In the embodiment of FIG. 13, the fixing means including the connector members 14 and 15 and the pin 16 is employed in combination with a stopper 19. In the embodiment of FIG. 14, the fixing means including the hook 7 and the hook receiver 8 illustrated in FIG. 7 is employed in combination with a fixing means comprised of a band 17 and a band hanger 18. In these embodiments, a fixing operation is first conducted by use of the lower fixing means so that the antenna body 1 can be supported by the antenna fixing bracket 2. In this condition, the fixing operation is finalized with the upper fixing means comprised of the stopper 19 or the band 17. This makes it easy to perform the fixing operation.

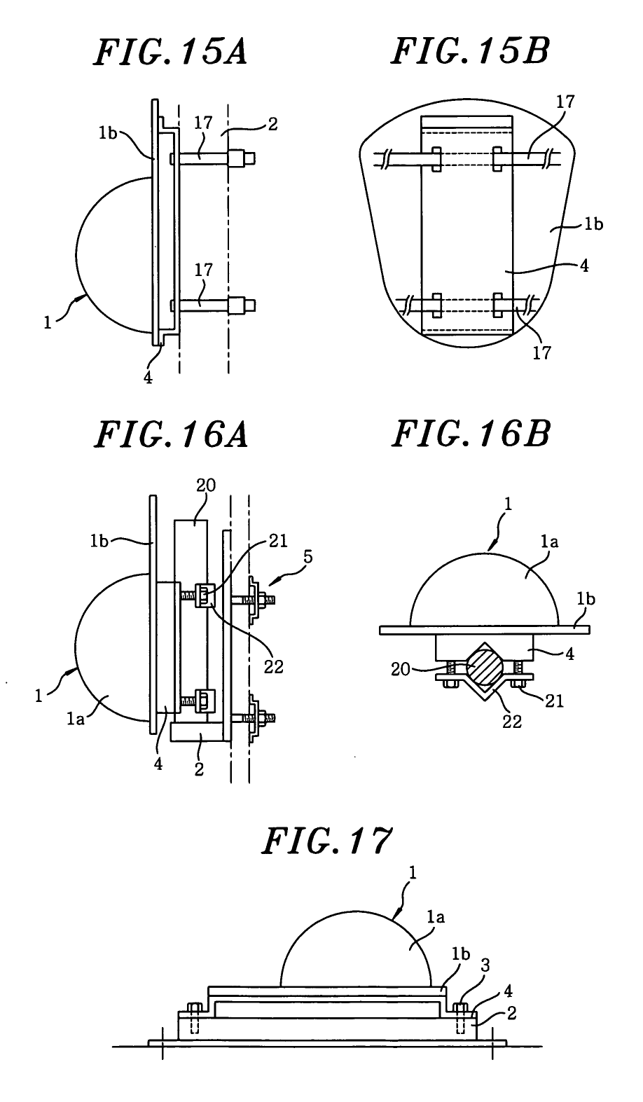

As shown in FIG. 15, a band 17 made of, e.g., stainless steel, may be provided on the antenna body 1. The band 17 is wound around the part of a fence or the like at which the antenna device is to be installed, thus affixing the antenna body 1 to the antenna fixing bracket 2.

FIG. 16 illustrates a still another preferred embodiment wherein an upright mast 20 is included in the antenna fixing bracket 2 and sandwichedly positioned between the attachment 4 and a retainer 22. The retainer 22 is fastened to the attachment 4 by means of bolts 21, thereby affixing the antenna body 1 to the antenna fixing bracket 2. This structure makes it possible to install the antenna device with ease.

In the embodiments illustrated in FIGS. 1 through 16, the antenna fixing bracket 2 may be secured to the wall surface or the like by using an anchor bolt or the like. Alternatively, the antenna fixing bracket 2 may be provided with a hook such that it can be hung on the wall.

Although FIGS. 1 through 16 show the embodiments in which the antenna body 1 is arranged in a vertical direction, it would be possible to dispose the antenna body 1 in a horizontal direction. FIGS. 17 through 22 illustrate embodiments wherein the antenna body 1 is disposed in the horizontal orientation. In the horizontal orientation, it is desirable that, for the purpose of water drainage, the reflective plate 1b be slanted with respect to a horizontal plane by several degrees (enough to allow water drops to flow down naturally).

FIG. 17 shows a still another preferred embodiment wherein the attachment 4 provided on the rear surface of the reflective plate 1b is affixed to the antenna fixing bracket 2, by installing beforehand the antenna fixing bracket 2 at an antenna installation area, e.g., the rooftop of a building, by means of an anchor bolt or the like and then fitting bolts 3 into threaded holes formed in the antenna fixing bracket 2.

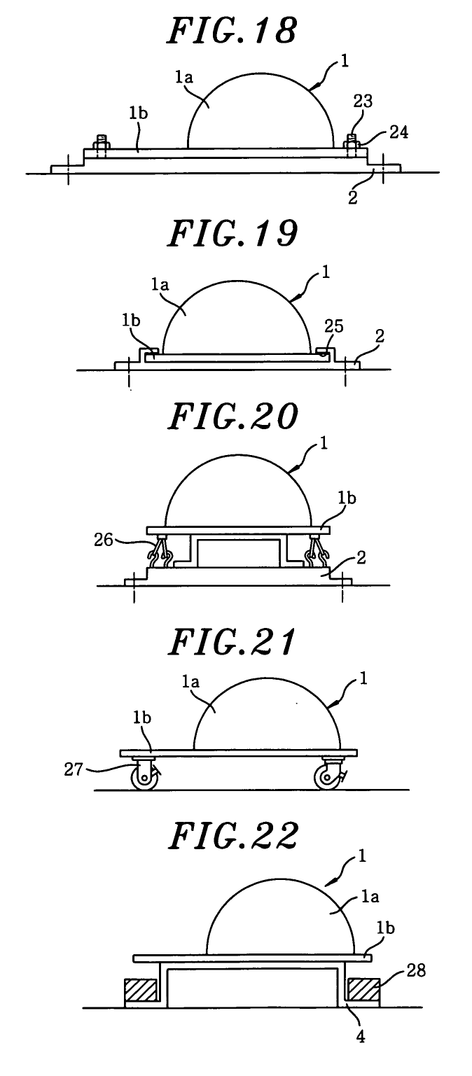

FIG. 18 shows a still another preferred embodiment wherein the antenna fixing bracket 2 is affixed to the antenna installation area by means of an anchor bolt or the like. In this embodiment, bolts 23 are integrally provided on the top surface of the antenna fixing bracket 2 and inserted through bolt-receiving holes formed on the reflective plate 1b, after which nuts 24 are tightened onto the bolts 23 to thereby affix the reflective plate 1b to the antenna fixing bracket 2.

FIG. 19 shows a still another preferred embodiment wherein the antenna fixing bracket 2 is affixed to the antenna installation area by means of an anchor bolt or the like. In this embodiment, an engaging groove 25 such as a T-shaped slot or a dovetail groove is provided on the antenna fixing bracket 2 and lateral edge portions of the reflective plate 1b is inserted into the engaging groove 25 from one side thereof, thus affixing the antenna body 1 to the antenna fixing bracket 2.

FIG. 20 shows a still another preferred embodiment wherein the antenna body 1 is affixed to the antenna fixing bracket 2 using a mooring member 26, e.g., a wire or a threaded shaft with a turnbuckle.

FIG. 21 shows a still another preferred embodiment wherein a caster 27 with a stopper is provided on the rear surface of the reflective plate 1b and the antenna body 1 is supported by the caster 27.

FIG. 22 shows a still another preferred embodiment wherein a weight 28 is used to affix the attachment 4 provided on the rear surface of the reflective plate 1b.

In the horizontally oriented antenna devices noted above, the antenna body 1 may be directly affixed to the antenna installation area, in which case the antenna fixing bracket 2 is excluded from essential elements. In case of the embodiments shown in FIGS. 17, 18 and 19, however, inclusion of the antenna fixing bracket 2 makes it possible to use the antenna body for dual purposes, namely, for the vertical orientation and the horizontal orientation.

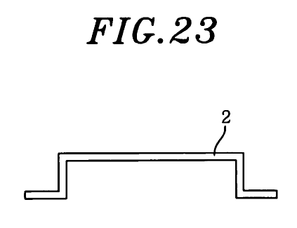

The antenna bodies illustrated in FIGS. 1-4, 8, 10 and 11-15 may also be used for the horizontal orientation by affixing the attachment 4 or the reflective plate 1b of the antenna body to an antenna fixing bracket 2 that has an inverted U-shape as shown in FIG. 23 and is secured to the antenna installation area by using an anchor bolts or the like.

Furthermore, the antenna body may be horizontally installed by use of an antenna fixing bracket that can be disposed in the horizontal direction on a wall. It would also be possible to install the antenna body in a horizontal direction by use of the vertically oriented antenna fixing bracket shown in FIG. 5, 6 or 15.

What is claimed is:

1. A Luneberg lens antenna device, comprising:
an antenna fixing bracket;
an antenna body including a hemispherical Luneberg lens and a reflective plate for reflecting radio waves; and
a fixing means for detachably affixing the reflective plate of the antenna body to the antenna fixing bracket,
wherein fixing parts for cooperating with the fixing means are provided in advance in the reflective plate and the antenna fixing bracket; the antenna fixing bracket is secured to an antenna installation area; and the reflective plate is affixed to the antenna fixing bracket by using the fixing means.

2. The Luneberg lens antenna device of claim 1, wherein the reflective plate or an attachment provided on a rear surface of the reflective plate is affixed to the antenna fixing bracket by using a bolt or a bolt-nut combination.

3. The Luneberg lens 3 antenna device of claim 1, wherein a hook and a hook receiver are provided in a mutually corresponding relationship on the reflective plate or an attachment provided on a rear surface of the reflective plate and on the antenna fixing bracket, and the reflective plate is hung on the antenna fixing bracket by using the hook and the hook receiver.

4. The Luneberg lens antenna device of claim 1, wherein a plug and a socket are provided in a mutually corresponding relationship on the reflective plate or an attachment provided on a rear surface of the reflective plate and on the antenna fixing bracket, and the reflective plate is affixed to the antenna fixing bracket by inserting the plug into the socket.

5. The Luneberg lens antenna device of claim 1, wherein an engaging groove is provided at the antenna fixing bracket; and opposite lateral edge portions of the reflective plate or an attachment provided on a rear surface of the reflective plate are brought into engagement with the engaging groove so that the reflective plate is supported by the antenna fixing bracket.

6. The Luneberg lens antenna device of claim 1, wherein connector members each having a pin hole are provided in a mutually corresponding relationship at the reflective plate and the antenna fixing bracket; and the reflective plate is affixed to the antenna fixing bracket by coupling the connector members with a pin.

7. The Luneberg lens antenna device of claim 1, wherein a band and a band hanger are provided in a mutually corresponding relationship on a rear surface of the reflective plate and the antenna fixing bracket, and the reflective plate is affixed to the antenna fixing bracket by tying the band to the band hanger.

8. The Luneberg lens antenna device of claim 1, wherein an upright pole is provided at the antenna fixing bracket and the reflective plate is affixed to the antenna fixing bracket by fastening, with a bolt, a metal retainer to an attachment provided on a rear surface of the reflective plate in such a manner that the upright pole is sandwichedly positioned between the attachment and the metal retainer.
